(19) United States
(12) Patent Application Publication
(10) Pub. No.: US 2008/0059434 A1
(43) Pub. Date: Mar. 6, 2008

(54) API-ACCESSIBLE MEDIA DISTRIBUTION SYSTEM

(75) Inventors: Robert John Williams, San Francisco, CA (US); Stuart H. Statman, Seattle, WA (US); Joshua Daniel Wright, Seattle, WA (US)

Correspondence Address: HOLLAND & KNIGHT LLP, 10 ST. JAMES AVENUE, BOSTON, MA, 02116, US

(73) Assignee: RealNetworks, Inc., Seattle, WA (US)

(21) Appl. No.: 11/848,811

(22) Filed: Aug. 31, 2007

Related U.S. Application Data
(60) Provisional application No. 60/842,056, filed on Aug. 31, 2006.
(60) Provisional application No. 60/843,212, filed on Sep. 8, 2006.

(51) Int. Cl. G06F 17/30; G06F 7/00

(52) U.S. Cl. 707/3; 707/10; 707/104.1; 707/E17.014

(57) ABSTRACT

A media distribution system and method for storing a plurality of media data files within a media repository. A user of a client electronic device is enabled to access one or more media data files chosen from the plurality of media data files. The user of the client electronic device is enabled to manage one or more subscription accounts associated with the media distribution system.

### RELATED APPLICATION(S)

This application claims the benefit of the following application(s): U.S. Provisional Patent Application No. 60/842,056, entitled “API-Accessible Media Distribution System”, filed 31 Aug. 2006, and U.S. Provisional Patent Application No. 60/843,212, entitled “API-Accessible Media Distribution System”, filed 8 Sep. 2006.

### TECHNICAL FIELD

This disclosure relates to media distribution systems and, more particularly, to API-accessible media distribution systems.

### BACKGROUND

Media distribution systems (e.g., the Rhapsody™ service offered by RealNetworks, Inc. of Seattle, Wash.) distribute media data files to a user's client electronic device (e.g., a personal media player, a personal digital assistant, or a multimedia cellular telephone) from a media server. A media distribution system may distribute media data files by allowing a user to e.g., receive downloaded media data files and/or stream remote media data files.

Unfortunately, a dedicated client application is often required to access a media distribution system. Further, as this dedicated client application is typically executed on a personal computer (e.g., a desktop computer or a laptop computer), the media distribution system may not be directly accessible by the client electronic device.

### SUMMARY OF DISCLOSURE

In a first implementation, a media distribution system includes a media repository for storing a plurality of media data files. An account application programming interface enables a user of a client electronic device to access one or more media data files chosen from the plurality of media data files. The account application programming interface is configured to enable the user of the client electronic device to manage one or more subscription accounts associated with the media distribution system.

One or more of the following features may be included. The account application programming interface may include one or more servers stubs that are configured to communicate with one or more client stubs. The account application programming interface may be further configured to: receive a data request, using a standardized protocol, from the client electronic device; and provide data, in response to the received data request, to the client electronic device in a third party usable format.

In another implementation, a method includes storing a plurality of media data files within a media repository. A user of a client electronic device is enabled to access one or more media data files chosen from the plurality of media data files. The user of the client electronic device is enabled to manage one or more subscription accounts associated with the media distribution system.

In another implementation, a media distribution system includes a media repository for storing a plurality of media data files. A library management application programming interface enables a user of a client electronic device to access one or more media data files chosen from the plurality of media data files. The library management application programming interface is configured to enable the user of the client electronic device to manage one or more media libraries associated with the media distribution system.

One or more of the following features may be included. The library management application programming interface may include one or more servers stubs that are configured to communicate with one or more client stubs. The library management application programming interface may be further configured to: receive a data request, using a standardized protocol, from the client electronic device; and provide data, in response to the received data request, to the client electronic device in a third party usable format.

In another implementation, a method includes storing a plurality of media data files within a media repository. A user of a client electronic device is enabled to access one or more media data files chosen from the plurality of media data files. The user of the client electronic device is enabled to manage one or more media libraries associated with the media distribution system.

In another implementation, a media distribution system includes a media repository for storing a plurality of media data files. A metadata application programming interface enables a user of a client electronic device to access one or more media data files chosen from the plurality of media data files. The metadata application programming interface is configured to enable the user of the client electronic device to define one or more search terms. A query is executed on at least a portion of the plurality of media data files, based on the one or more search terms. A result set is generated, and a portion of the result set is displayed to the user, such that the portion is less than the entire result set.

One or more of the following features may be included. The metadata application programming interface may include one or more servers stubs that are configured to communicate with one or more client stubs. The metadata application programming interface may be further configured to: receive a data request, using a standardized protocol, from the client electronic device; and provide data, in response to the received data request, to the client electronic device in a third party usable format.

In another implementation, a method includes storing a plurality of media data files within a media repository. A user of a client electronic device is enabled to access one or more media data files chosen from the plurality of media data files. The user of the client electronic device is enabled to define one or more search terms. A query is executed on at least a portion of the plurality of media data files, based on the one or more search terms. A result set is generated. A portion of the result set is displayed to the user, such that the portion is less than the entire result set.

In another implementation, a media distribution system includes a media repository for storing a plurality of media data files. A playback application programming interface enables a user of a client electronic device to access one or more media data files chosen from the plurality of media data files. The playback application programming interface is configured to monitor the number of connections, established by the user, with the music distribution system. A maximum connection policy is enforced that limits the number of connections establishable by the user to a defined connection limit.

One or more of the following features may be included. The playback application programming interface may include one or more servers stubs that are configured to communicate with one or more client stubs. The playback application programming interface may be further configured to: receive a data request, using a standardized protocol, from the client electronic device; and provide data, in response to the received data request, to the client electronic device in a third party usable format.

In another implementation, a method includes storing a plurality of media data files within a media repository. A user of a client electronic device is enabled to access one or more media data files chosen from the plurality of media data files. The number of connections, established by the user, with a media distribution system is monitored. A maximum connection policy that limits the number of connections establishable by the user to a defined connection limit is enforced.

In another implementation, a media distribution system includes a media repository for storing a plurality of media data files. A search application programming interface enables a user of a client electronic device to access one or more media data files chosen from the plurality of media data files. The search application programming interface is configured to enable a user to define a first search term, and execute a first query of at least a portion of the plurality of media data files, based on the first search term. A user is enabled to define a second search term, and execute a second query of at least a portion of the plurality of media data files, based on the first and second search terms.

One or more of the following features may be included. The search application programming interface may include one or more servers stubs that are configured to communicate with one or more client stubs. The search application programming interface may be further configured to: receive a data request, using a standardized protocol, from the client electronic device; and provide data, in response to the received data request, to the client electronic device in a third party usable format.

In another implementation, a method includes storing a plurality of media data files within a media repository. A user of a client electronic device is enabled to access one or more media data files chosen from the plurality of media data files. A user is enabled to define a first search term. A first query of at least a portion of the plurality of media data files is executed, based on the first search term. A user is enabled to define a second search term. A second query of at least a portion of the plurality of media data files is executed, based on the first and second search terms.

The details of one or more implementations are set forth in the accompanying drawings and the description below. Other features and advantages will become apparent from the description and the drawings.

### BRIEF DESCRIPTION OF THE DRAWINGS

FIG. 1 is a diagrammatic view of a media distribution system, a client application, a proxy application, and a personal media device coupled to a distributed computing network;

FIG. 2 is an isometric view of the personal media device of FIG. 1;

FIG. 3 is a diagrammatic view of the personal media device of FIG. 1;

FIG. 4 is a diagrammatic view of a data exchange with the media distribution system of FIG. 1;

FIG. 5 is a flowchart of a process executed by the media distribution system of FIG. 1;

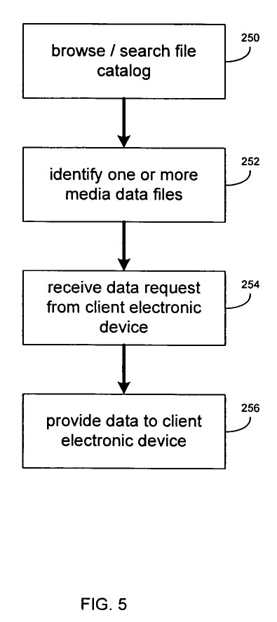

FIG. 6 is a flowchart of a process executed by the media distribution system of FIG. 1;

FIG. 7 is a flowchart of a process executed by the media distribution system of FIG. 1;

FIG. 8 is a flowchart of a process executed by the media distribution system of FIG. 1;

FIG. 9 is a flowchart of a process executed by the media distribution system of FIG. 1; and

FIG. 10 is a flowchart of a process executed by the media distribution system of FIG. 1.

### DETAILED DESCRIPTION OF EXEMPLARY EMBODIMENTS

System Overview:

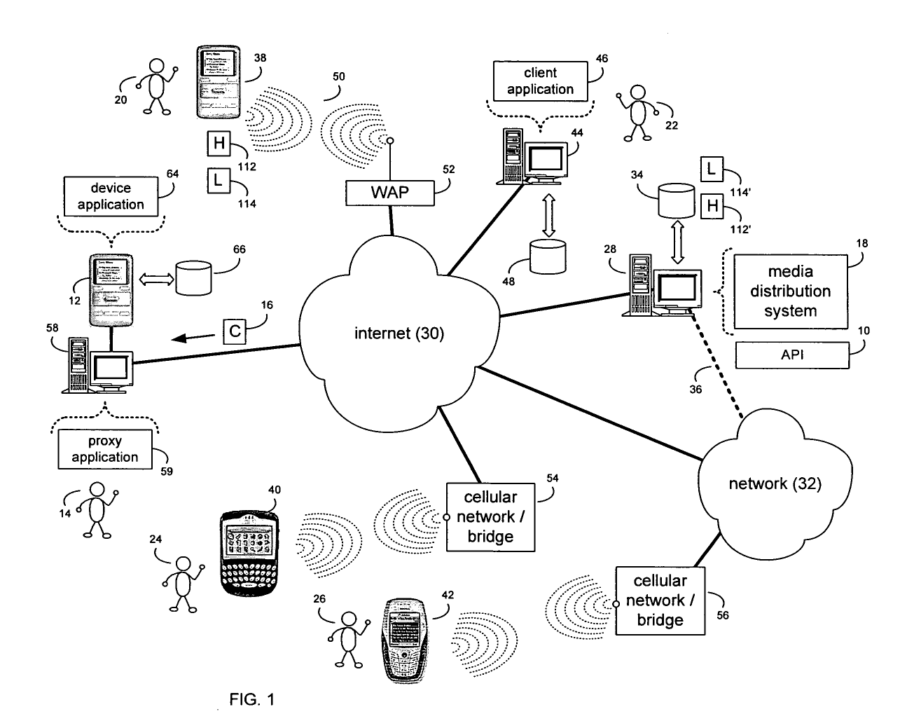

Referring to FIG. 1, there is shown an API (i.e., Application Programming Interface) 10 that allows e.g., personal media device 12 (and, therefore, user 14) to obtain media content 16 from media distribution system 18. Media content 16 may be, for example, digitally-encoded audio and/or video media data files that may be compressed using known compression techniques. Examples of such compression techniques may include but are not limited to MPEG-1, MPEG-2, MPEG-4, H.263, H.264, Advanced Audio Coding, and other techniques promulgated by the International Standards Organization (ISO) and the Motion Picture Experts Group (MPEG).

Examples of the format of media content 16 received from media distribution system 18 may include: purchased downloads received from media distribution system 18 (i.e., media content licensed to e.g., user 14 for use in perpetuity); subscription downloads received from media distribution system 18 (i.e., media content licensed to e.g., user 14 for use while a valid subscription exists with media distribution system 18); and media content streamed from media distribution system 18, for example. Typically, when media content is streamed from e.g., computer 28 to personal media device 12, a copy of the media content is not permanently retained on personal media device 12. In addition to media distribution system 18, media content may be obtained from other sources, examples of which may include but are not limited to files ripped from music compact discs.

Examples of the types of media content 16 distributed by media distribution system 18 include: audio media data files (examples of which may include but are not limited to music files, audio news broadcasts, audio sports broadcasts, and audio recordings of books, for example); video media data files (examples of which may include but are not limited to video footage that does not include sound, for example); audio/video media data files (examples of which may include but are not limited to a/v news broadcasts, a/v sports broadcasts, feature-length movies and movie clips, music videos, and episodes of television shows, for example); and multimedia content media data files (examples of which may include but are not limited to interactive presentations and slideshows, for example).

Media distribution system 18 may provide media data streams and/or media data files to a plurality of users (e.g., users 14, 20, 22, 24, 26). Examples of such a media distribution system 18 include the Rhapsody™ service offered by RealNetworks, Inc. of Seattle, Wash.

Media distribution system 18 may be a server application that resides on and is executed by computer 28 (e.g., a server computer) that is connected to network 30 (e.g., the Internet). Computer 28 may be a web server running a network operating system, examples of which may include but are not limited to Microsoft Windows XP Server™, Novell Netware™, or Redhat Linux™.

Computer 28 may also execute a web server application, examples of which may include but are not limited to Microsoft IIS™, Novell Webserver™, or Apache Webserver™, that allows for HTTP (i.e., HyperText Transfer Protocol) access to computer 28 via network 30. Network 30 may be connected to one or more secondary networks (e.g., network 32), such as: a local area network; a wide area network; or an intranet, for example.

The instruction sets and subroutines of media distribution system 18 and API 10, which may be stored on storage device 34 coupled to computer 28, may be executed by one or more processors (not shown) and one or more memory architectures (not shown) incorporated into computer 28. Additionally, the media data files available from media distribution system 18 may be stored on e.g., storage device 34 attached to computer 28. Storage device 34 may include but is not limited to a hard disk drive, a tape drive, an optical drive, a RAID array, a random access memory (RAM), or a read-only memory (ROM).

Users 14, 20, 22, 24, 26 may access media distribution system 18 through e.g., network 30 and/or secondary network 32. Further, computer 28 (i.e., the computer that executes media distribution system 18) may be connected to network 30 through secondary network 32, as illustrated with phantom link line 36.

Media distribution system 18 may be accessed directly or may be accessed through a proxy computer. For example, users 20, 24, 26 may directly access media distribution system 18 through various client electronic devices, examples of which may include, but are not limited to: personal media device 38; personal digital assistant 40; cellular telephone 42; televisions (not shown); cable boxes (not shown); internet radios (not shown); or dedicated network devices (e.g., A Roku™ Soundbridge M500, M1000 and M2000; not shown), for example. Additionally/alternatively, media distribution system 18 may be directly accessed via client computer 44.

Additionally, the devices directly accessing media distribution system 18 may be directly coupled to network 30 (or network 32). For example, client computer 44 is shown directly coupled to network 30 via a hardwired network connection. Further, client computer 44 may execute a client application 46 (examples of which may include but are not limited to Microsoft Internet Explorer™ available from Microsoft Inc, of Redmond, Wash., Netscape Navigator™, Rhapsody™ client & RealPlayer™ client available from RealNetworks, Inc. of Seattle, Wash., or a specialized interface) that allows e.g., user 22 to access and configure media distribution system 18 via network 30 (or network 32). Client computer 44 may run an operating system, examples of which may include but are not limited to Microsoft Windows XP™, or Redhat Linux™.

The instruction sets and subroutines of client application 46, which may be stored on a storage device 48 coupled to client computer 44, may be executed by one or more processors (not shown) and one or more memory architectures (not shown) incorporated into client computer 44. Storage device 48 may include but is not limited to a hard disk drive, a tape drive, an optical drive, a RAID array, a random access memory (RAM), or a read-only memory (ROM).

Alternatively, the devices directly accessing media distribution system 18 may be indirectly coupled to network 30 (or network 32). For example, personal media device 38 is shown wirelessly coupled to network 30 via a wireless communication channel 50 established between personal media device 38 and wireless access point (i.e., WAP) 52, which is shown directly coupled to network 30. WAP 52 may be, for example, an IEEE 802.11a, 802.11b, 802.11g, Wi-Fi, and/or Bluetooth device that is capable of establishing communication channel 50 between personal media device 38 and WAP 52.

As is known in the art, the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Additionally, personal digital assistant 40 is shown wirelessly coupled to network 30 via cellular/network bridge 54 (which is shown directly coupled to network 30); and cellular telephone 42 is shown wirelessly coupled to network 32 via a cellular/network bridge 56 (which is shown directly coupled to network 32).

In addition to directly accessing media distribution system 18, client electronic devices may indirectly access media distribution system 18 through a proxy computer. For example, personal media device 12 is shown to access media distribution system 18 through proxy computer 58. Proxy computer 58 may execute proxy application 59. which may have functionality similar to that of client application 46.

Client Electronic Devices:

As discussed above, examples of client electronic devices may include personal media devices 12, 38, personal digital assistant 40, and cellular telephone 42. Accordingly, while the following disclosure is directed towards personal media device 12, 38, it is understood that the following disclosure may be equally applied to any client electronic device (including personal digital assistant 40, cellular telephone 42, televisions (not shown); cable boxes (not shown); internet radios (not shown); and dedicated network devices (not shown).

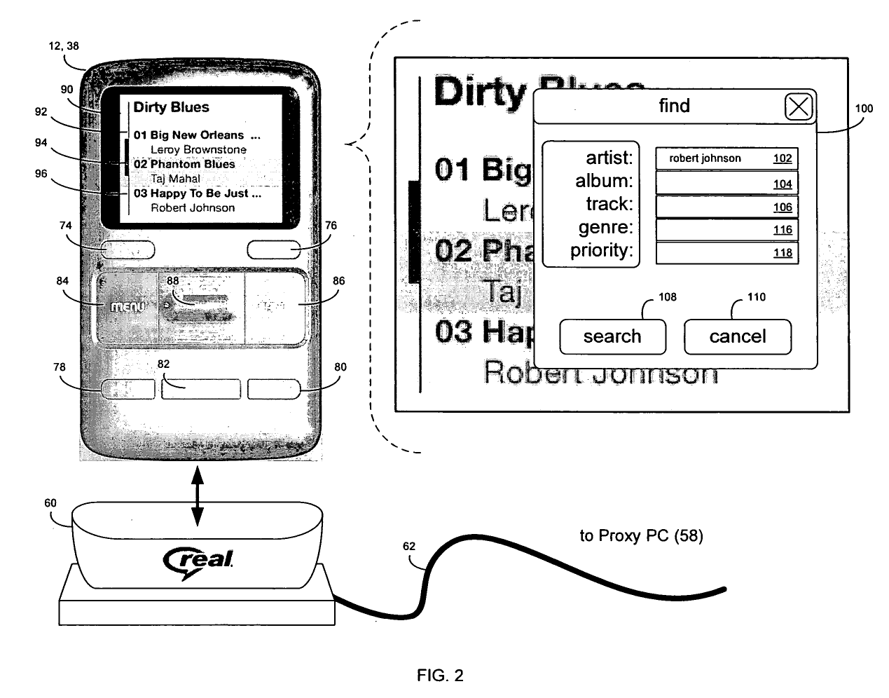

Referring also to FIG. 2, personal media device 12, 38 may be connected to e.g., proxy computer 58 via a docking cradle 60. Typically, personal media device 12, 38 includes a bus interface (to be discussed below in greater detail) that couples personal media device 12, 38 to docking cradle 60. Docking cradle 60 may be coupled (with cable 62) to e.g., a Universal Serial Bus (i.e., USB) port, a serial port, or an IEEE 1394 (i.e., FireWire) port included within proxy computer 58. For example, the bus interface included within personal media device 12, 38 may be a USB interface, and docking cradle 60 may function as a USB hub (i.e., a plug-and-play interface that allows for “hot” coupling and uncoupling of personal media device 12, 38 and docking cradle 60).

Proxy computer 58 may function as an Internet gateway for personal media device 12, 38. For example, through the use of e.g., the universal plug and play protocol (i.e., UPnP), personal media device 12, 38 may use proxy computer 58 to access media distribution system 18 via network 30 (and network 32) and obtain media content 16. Specifically, upon receiving a request for media distribution system 18 from personal media device 12, 38, proxy computer 58 (acting as an Internet client on behalf of personal media device 12, 38), may request the appropriate web page/service from computer 28 (i.e., the computer that executes media distribution system 18). When the requested web page/service is returned to proxy computer 58, proxy computer 58 may relate the returned web page/service to the original request (placed by personal media device 12, 38) and may forward the web page/service to personal media device 12, 38. Accordingly, proxy computer 58 may function as a conduit for coupling personal media device 12, 38 to computer 28 and, therefore, media distribution system 18.

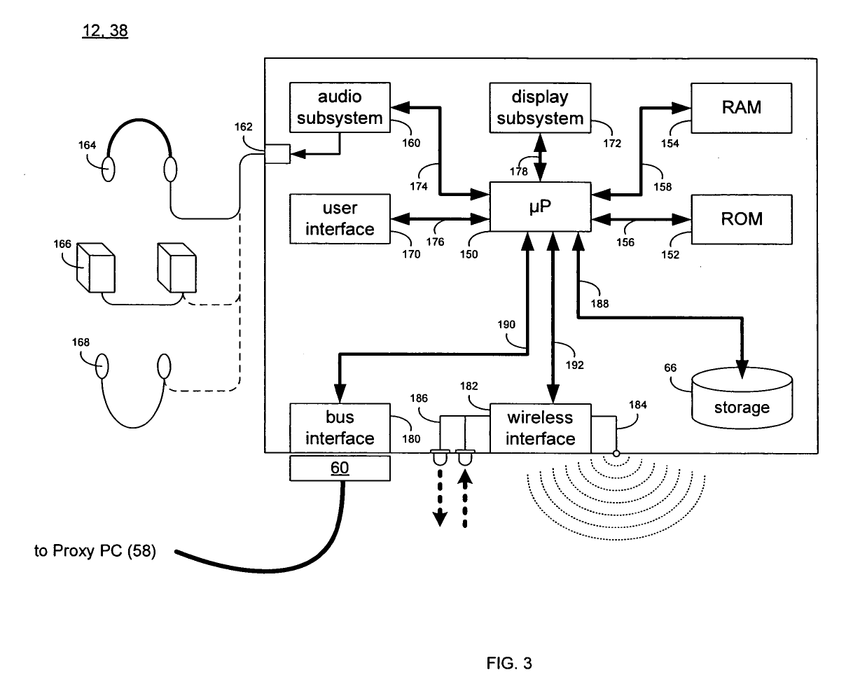

Referring also to FIG. 3, a diagrammatic view of personal media device 12, 38 is shown. Personal media device 12, 38 may include microprocessor 150 (e.g., an ARM™ microprocessor produced by Intel Corporation of Santa Clara, Calif.), non-volatile memory (e.g., read-only memory 152), and volatile memory (e.g., random access memory 154); each of which may be interconnected via one or more data/system buses 156, 158. Personal media device 12, 38 may also include an audio subsystem 160 for providing e.g., an analog audio signal to an audio jack 162 for removable engaging e.g., a headphone assembly 164, a remote speaker assembly 166, or an ear bud assembly 168, for example. Alternatively, personal media device 12, 38 may be configured to include one or more internal audio speakers (not shown).

Personal media device 12, 38 may execute a device application 64 (examples of which may include but are not limited to Rhapsody™ client, RealPlayer™ client, or a specialized interface). Personal media device 12, 38 may run an operating system, examples of which may include but are not limited to Microsoft Windows CE™, Redhat Linux™, Palm OS™, or a device-specific (i.e., custom) operating system.

The instruction sets and subroutines of device application 64, which may be stored on a storage device 66 coupled to personal media device 12, 38, may be executed by one or more processors (not shown) and one or more memory architectures (not shown) incorporated into personal media device 12, 38. Storage device 66 may be, for example, a hard disk drive, an optical drive, a random access memory (RAM), a read-only memory (ROM), a CF (i.e., compact flash) card, an SD (i.e., secure digital) card, a SmartMedia card, a Memory Stick, and a MultiMedia card, for example.

Personal media device 12, 38 may also include a user interface 170 and a display subsystem 172. User interface 170 may receive data signals from various input devices included within personal media device 12, 38, examples of which may include (but are not limited to): rating switches 74, 76; backward skip switch 78; forward skip switch 80; play/pause switch 82; menu switch 84; radio switch 86; and slider assembly 88, for example. Display subsystem 172 may provide display signals to display panel 90 included within personal media device 12, 38. Display panel 90 may be an active matrix liquid crystal display panel, a passive matrix liquid crystal display panel, or a light emitting diode display panel, for example.

Audio subsystem 160, user interface 170, and display subsystem 172 may each be coupled with microprocessor 150 via one or more data/system buses 174, 176, 178 (respectively).

During use of personal media device 12, 38, display panel 90 may be configured to display e.g., the title and artist of various pieces of media content 92, 94, 96 stored within personal media device 12, 38. Slider assembly 88 may be used to scroll upward or downward through the list of media content stored within personal media device 12, 38. When the desired piece of media content is highlighted (e.g., “Phantom Blues” by “Taj Mahal”), user 14 may select the media content for rendering using play/pause switch 82. User 14 may skip forward to the next piece of media content (e.g., “Happy To Be Just . . . ” by “Robert Johnson”) using forward skip switch 80; or skip backward to the previous piece of media content (e.g., “Big New Orleans . . . ” by “Leroy Brownstone”) using backward skip switch 78. Additionally, user 14 may rate the media content as they listen to it by using rating switches 74, 76.

The user may use display panel 90 in conjunction with e.g., slider assembly 88 to search/browse the media content stored within personal media device 12, 38 and/or available from media distribution system 18. For example, to render search screen 100, the user may depress and hold slider assembly 88. Search screen 100 may include an artist field 102, an album field 104, and a track field 106. Using e.g., slider assembly 88, the user may navigate fields 102, 104, 106 and enter the appropriate search terms into the appropriate field. For example, the user may enter the phrase “Robert Johnson” into artist field 102. When populating field 102, slider assembly 88 may be used to enter the appropriate characters. For example, an upward or a downward movement of slider assembly 88 may allow the user to move between the fields and a depression of slider assembly 88 may result in a particular field being selected. Once selected, an upward or a downward movement of slider assembly 88 may enable the user to select the appropriate character and a depression of slider assembly 88 may result in the character being selected. Alternatively, personal media device 12, 38 may be configured to include a full or a partial keyboard (not shown). Once the search terms are defined, the user may select “search” button 108 or (alternatively) “cancel” button 110.

As discussed above, personal media device 12, 38 may include a bus interface 180 for interfacing with e.g., proxy computer 58 via docking cradle 60. Additionally and as discussed above, personal media device 12, 38 may be wirelessly coupled to network 30 (and/or other personal media devices) via e.g., a wireless communication channel 50 established between personal media device 12, 38 and e.g., WAP 52. Accordingly, personal media device 12, 38 may include a wireless interface 182 for wirelessly-coupling personal media device 12, 38 to network 30 (or network 32) and/or other personal media devices. Wireless interface 182 may be coupled to an antenna assembly 184 for RF communication to e.g., WAP 52, and/or an IR (i.e., infrared) communication assembly 186 for infrared communication with e.g., a second personal media device. Further and as discussed above, personal media device 12, 38 may include a storage device 66 for storing the instruction sets and subroutines of device application 64. Additionally, storage device 66 may be used to store media data files downloaded from media distribution system 18 and to temporarily store media data streams (or portions thereof) streamed from media distribution system 18.

Storage device 66, bus interface 180, and wireless interface 182 may each be coupled with microprocessor 150 via one or more data/system buses 188, 190, 192 (respectively).

As discussed above, media distribution system 18 may distribute media content to users 14, 20, 22, 24, 26, such that the media content distributed may be in the form of media data streams and/or media data files.

Accordingly, media distribution system 18 may be configured to only allow users to download media data files. For example, user 20 may be allowed to download, from media distribution system 18, media data files (i.e., examples of which may include but are not limited to audio files encoded and compressed using an MP3 encoder or an Advanced Audio Coding (AAC) encoder, or digital video encoded files), such that copies of the media data file are transferred to personal media device 38.

Alternatively, media distribution system 18 may be configured to only allow users to receive and process media data streams of media data files. For example, user 24 may be allowed to receive and process (on personal digital assistant 40) media data streams received from media distribution system 18. As discussed above, when media content is streamed from e.g., computer 28 to personal digital assistant 40, a copy of the media data file may not be permanently retained on personal digital assistant 40.

Further, media distribution system 18 may be configured to allow users to receive and process media data streams and download media data files. Examples of such a media distribution system include the Rhapsody™ service offered by RealNetworks, Inc. of Seattle, Wash. Accordingly, user 26 may be allowed to download digital encoded media data files and receive and process media data streams from media distribution system 18. Therefore, copies of media data files may be transferred from computer 28 to cellular telephone 42; and streams of media data files may be received from computer 28 by cellular telephone 42.

Direct Access:

As discussed above, media distribution system 18 may be accessed directly or may be accessed through a proxy computer. For example, users 20, 24, 26 may directly access media distribution system 18 through various client electronic devices, examples of which may include, but are not limited to: personal media device 38; personal digital assistant 40; cellular telephone 42; televisions (not shown); cable boxes (not shown); internet radios (not shown); or dedicated network devices (not shown); for example.

When directly accessing media distribution system 18, a standardized protocol may be used. For example, SOAP (i.e., Simple Object Access Protocol) may be used to couple a client electronic device (e.g., personal media device 38; personal digital assistant 40; cellular telephone 42) to media distribution system 18.

As is known in the art, the SOAP protocol allows XML (eXtensible Markup Language) messages to be exchanged across computer networks (e.g., networks 30, 32). These message may be exchanged using HTTP (i.e., HyperText Transfer Protocol).

SOAP may use the RPC (i.e., Remote Procedure Protocol) process, in which a first network node (e.g. personal media device 38) sends a request message to another network node (e.g., computer 28), and the second network node (e.g., computer 28) sends a response message to the first network node (e.g., personal media device 38). While the system is described above as utilizing SOAP, other configurations are possible and are considered to be within the scope of this disclosure. For example, other protocols may be used, such a JSON (i.e., Java Script Object Notation), REST (i.e., REpresentational State Transfer), and XML-RPC (i.e., eXtensible Markup Language Remote Procedure Protocol).

Application Programming Interface:

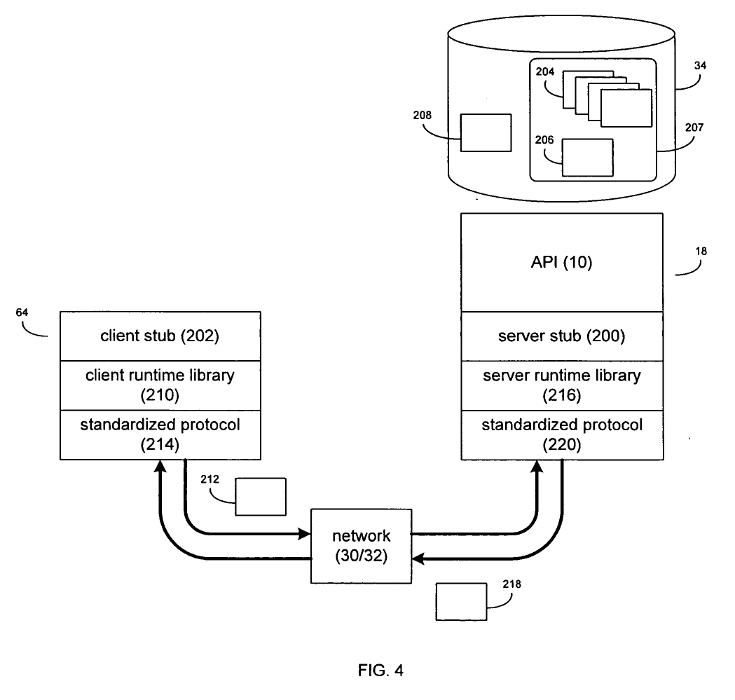

Referring also to FIGS. 4 & 5 and as discussed above, media distribution system 18 may include API 10 to enable communication between computer 28 and personal media device 38, personal digital assistant 40, and cellular telephone 42.via e.g., SOAP. Additionally and as will be discussed below in greater detail, media distribution system 18/API 10 may include one or more server stubs 200 to interact with one or more client stubs 202 included within device application 64.

API 10 may act as an interface for media distribution system 18 that allows requests for services to be made of media distribution system 18 by other computer programs (e.g., device application 64) and/or allows data to be retrieved from and/or provided to media distribution system 18.

API 10 may describe how device application 64 may access a set of functions (within media distribution system 18) without granting access to the source code of the functions (within media distribution system 18) or requiring a detailed understanding of the internal workings of the functions (within media distribution system 18).

As discussed above, media distribution system 18 provides media data files (in the form of downloads or streams) 204 to e.g., client electronic devices, such as: personal media device 12, 38; personal digital assistant 40; and cellular telephone 42. Media distribution system 18 may also maintain file catalog 206 that indexes media data files 204 and allows users to search/browse the media data files 204 available through media distribution system 18. File catalog 206 may be maintained on storage device 34 coupled to computer 28. Media data files 204 and/or file catalog 206 may be included within media repository 207. Any example of media repository 207 may include a database, such as an Oracle™ database, an IBM DB2™ database, a Sybase™ database, a Computer Associates™ database or a Microsoft Access™ database.

As will be discussed below in greater detail, API 10 may be configured to enable a user of a client electronic device (e.g., personal media devices 12, 38, personal digital assistant 40, and cellular telephone 42) to browse/search 250 file catalog 206 and identify 252 one or more media data files chosen from the plurality of media data files 204. Further, API 10 may be configured to receive 254 a data request, using a standardized protocol, from a client electronic device (e.g., personal media device 12, 38, personal digital assistant 40, and cellular telephone 42) and provide 256 data, in response to the received data request, to the client electronic device (e.g., personal media device 12, 38, personal digital assistant 40, and cellular telephone 42) in a third party usable format.

Configuring the Client Electronic Devices:

When configuring a client electronic device (e.g., personal media device 12, 38, personal digital assistant 40, and cellular telephone 42) to directly access media distribution system 18, a standardized protocol may be established between the two devices (e.g., the client electronic device and computer 28). As discussed above, an example of such a standardized protocol is SOAP. Once the standardized protocol is established and the devices are capable of communicating with each other, one or more WSDLs (i.e., Web Services Description Language) 208 resident on e.g., storage device 34 may be processed by the client electronic device to automate the generation of any required client stubs (e.g., client stub 202).

WSDL 208 is a service description (typical XML) describing how a client device may communicate with a web service. For example, WSDL 208 may describe how device application 64 (and, therefore, a client electronic device) may communicate with media distribution system 18/API 10. Further, WSDL 208 may define e.g., the protocol bindings and message formats required to interact with media distribution system 18. Typically, the supported operations and messages are described abstractly, and then bound to the network protocol (e.g., SOAP). Accordingly, WSDL 208 may define the public interface for media distribution system 18.

Accordingly, when configuring a client electronic device to directly access media distribution system 18, once communication is established (using a standardized protocol) between computer 28 (i.e., the computer that executes media distribution system 18) and a client electronic device (e.g., personal media device 12, 38, personal digital assistant 40, and cellular telephone 42), the client electronic device may obtain one or more WSDLs 208 (from computer 28) and process them to generate the appropriate client stubs (e.g., client stub 202) for the services/functions that the client electronic device wishes to access. Examples of WSDLs 208 are as follows:

An Account Management WSDL (Example #1)

<?xml version=“1.0” encoding=“UTF-8” ?>
- <wsdl:definitions targetNamespace=“urn:rhapsodydirectaccountmgmt”
xmlns: apachesoap=“http://xml.apache.org/xml-soap”
xmlns: impl=“urn:rhapsodydirectaccountmgmt” xmlns:intf=“urn:rhapsodydirectaccountmgmt”
xmlns: soapenc=“http://schemas.xmlsoap.org/soap/encoding/”
xmlns:tns1=“http://kani.common.real.com” xmlns:wsdl=“http://schemas.xmlsoap.org/wsdl/”
xmlns:wsdlsoap=“http://schemas.xmlsoap.org/wsdl/soap/”
xmlns:xsd=“http://www.w3.org/2001/XMLSchema”>
-<!--
WSDL created by Apache Axis version: 1.4
Built on Apr. 22, 2006 (06:55:48 PDT)
   -->
-<wsdl:types>
- <schema targetNamespace=“http://kani.common.real.com”
xmlns=“http://www.w3.org/2001/XMLSchema”>
   <import namespace=“urn:rhapsodydirectaccountmgmt” />
   <import namespace=“http://schemas.xmlsoap.org/soap/encoding/” />
- <complexType name=“MemberCredentials”>
- <sequence>
   <element name=“cobrand” nillable=“true” type=“xsd:string” />
   <element name=“logon” nillable=“true” type=“xsd:string” />
   <element name=“password” nillable=“true” type=“xsd:string” />
   </sequence>
   </complexType>
- <complexType name=“UpgradeMemberAccountResult”>
- <sequence>
   <element name=“upgradeResult” type=“xsd:boolean” />
   <wsdlsoap:body use=“encoded” encodingStyle=“http://schemas.xmlsoap.org/soap/encoding/” namespace=“urn:rhapsodydirectsearch” />
   </wsdl:output>
   </wsdl:operation>
- <wsdl:operation name=“searchComposersByName”>
   <wsdlsoap:operation />
- <wsdl:input>
   <wsdlsoap:body use=“encoded” encodingStyle=“http://schemas.xmlsoap.org/soap/encoding/” namespace=“urn:rhapsodydirectsearch” />
   </wsdl:input>
- <wsdl:output>
   <wsdlsoap:body use=“encoded” encodingStyle=“http://schemas.xmlsoap.org/soap/encoding/” namespace=“urn:rhapsodydirectsearch” />
   </wsdl:output>
   </wsdl:operation>
- <wsdl:operation name=“searchTracksByKeywords”>
   <wsdlsoap:operation />
- <wsdl:input>
   <wsdlsoap:body use=“encoded” encodingStyle=“http://schemas.xmlsoap.org/soap/encoding/” namespace=“urn:rhapsodydirectsearch” />
   </wsdl:input>
- <wsdl:output>
   <wsdlsoap:body use=“encoded” encodingStyle=“http://schemas.xmlsoap.org/soap/encoding/” namespace=“urn:rhapsodydirectsearch” />
   </wsdl:output>
   </wsdl:operation>
- <wsdl:operation name=“searchTracksByName”>
   <wsdlsoap:operation />
- <wsdl:input>
   <wsdlsoap:body use=“encoded” encodingStyle=“http://schemas.xmlsoap.org/soap/encoding/” namespace=“urn:rhapsodydirectsearch” />
   </wsdl:input>
- <wsdl:output>
   <wsdlsoap:body use=“encoded” encodingStyle=“http://schemas.xmlsoap.org/soap/encoding/” namespace=“urn:rhapsodydirectsearch” />
   </wsdl:output>
   </wsdl:operation>
   </wsdl:binding>
- <wsdl: service name=“RhapsodyDirectSearchAxisAdapterService”>
- <wsdl:port name=“RhapsodyDirectSearch”
binding=“impl:RhapsodyDirectSearchSoapBinding”>
   <wsdlsoap:address location=“http://direct.rhapsody.com/search/services/RhapsodyDirectSearch” />
   </wsdl:port>
   </wsdl: service>
- <!--
WSDL created by Apache Axis version: 1.4
Built on Apr. 22, 2006 (06:55:48 PDT)<
   -->
   </wsdl:definitions>

When generating WSDLs, the manner in which the WSDLs are configured (and therefore the clients stubs are generated) may vary based on the intent of the programmer. For example, a single WSDL may be designed to generate clients stubs for all services/functions of media distribution system 18. Alternatively, separate WSDLs may be made available for each service/function available within media distribution system 18. For example, the first WSDL (shown above) may be made available to generate a client stub for the account management services/functions of media distribution system 18; the second WSDL (shown above) may be made available to generate a client stub for the library management services/functions of media distribution system 18; the third WSDL (shown above) may be made available to generate a client stub for the metadata services/functions of media distribution system 18; the fourth WSDL (shown above) may be made available to generate a client stub for the playback services/functions of media distribution system 18; and the fifth WSDL (shown above) may be made available to generate a client stub for the search services/functions of media distribution system 18

Once the appropriate clients stubs (e.g., client stub 202) are generated to allow the client electronic device (e.g., personal media device 12, 38, personal digital assistant 40, and cellular telephone 42) to access the various services/functions of media distribution system 18, the client electronic device may be capable of: e.g., browsing/searching 250 file catalog 206; identifying 252 one or more media data files chosen from the plurality of media data files 204; receiving 254 data request(s), using a standardized protocol, from a client electronic device; and providing 256 data, in response to the received data request(s), to the client electronic device in a third party usable format. Examples of the various services/functions of media distribution system 18 include: search services/functions; account management services/functions; playback services/functions; metadata services/functions; and library services/functions.

RPC Communication:

As discussed above, SOAP may use the RPC (i.e., Remote Procedure Protocol) process, in which a first network node (e.g. personal media device 38) sends a request message to another network node (e.g., computer 28), and the second network node (e.g., computer 28) sends a response message to the first network node (e.g., personal media device 38).

The RPC process typically starts on the client side (e.g., within device application 64). Device application 64 may call client stub 202 which, as described above, is generated (typically using WSDLs) to allow access to the various services/functions of media distribution system 18. Typically, instead of containing code that implements the services/functions, client stub 202 may retrieve the required parameters from device application 64 and may provide them to client runtime library 210. The parameters obtained from device application 64 may e.g., define search terms for use when browsing/searching 250 file catalog 202, identify 252 one or more media data files 200 for download, request or transmit metadata from or to computer 28, add or remove an entry to or from a user's library, or set up or cancel a subscription account, for example.

Client runtime library 210 may translate the parameters (as obtained from device application 64) into an NDR (i.e., Network Data Representation) formatted message 212. Message 212 may be transmitted using standardized protocol 214 (e.g., SOAP) to computer 28 (i.e., the computer that executes media distribution system 18) via network 30, 32. Client runtime library 210 may be an object library of routines that supports the functionality of client stub 202.

When computer 28 receives 254 NDR message 212 from the client electronic device, server runtime library 216 may accept NDR message 212 and call server stub 200. Server stub 200 may retrieve the parameters included within message 212 and convert them from the network transmission format (i.e., the NDR format) to a format usable by computer 28. Once converted, server stub 200 may call the requested service/function within media distribution system 18.

Once the requested service/function within media distribution system 18 is executed, one or more output parameters may be generated (on computer 28). The output parameters generated by media distribution system 18 may e.g., define search results, acknowledge receipt of a download request, or acknowledge receipt of metadata, for example.

Server runtime library 216 may translate the output parameters (as generated by media distribution system 18) into an NDR-formatted message 218. Message 218 may be provided 256 (i.e., using standardized protocol 220 (e.g., SOAP)) to the client electronic device (e.g., personal media device 12, 38, personal digital assistant 40, or cellular telephone 42) via network 30, 32. Server runtime library 216 may be an object library of routines that supports the functionality of server stub 200.

When the client electronic device receives NDR message 218 from computer 28, client runtime library 210 may accept NDR message 218 and call client stub 202. Client stub 202 may retrieve the output parameters included within message 218 and convert them from the network transmission format (i.e., the NDR format) to a format usable by the client electronic device.

As discussed above, the data provided to the client electronic devices may be provided in a third party usable format (i.e., a standardized format that is usable by third party applications. An example of such a format is XML. Accordingly, one or more of messages 212, 218 may be XML-based messages processable by various applications (e.g., a web browser).

Specialized APIs:

As discussed above, when generating WSDLs, the manner in which the WSDLs are configured (and therefore the clients stubs are generated) may vary based on the intent of the programmer. For example, separate WSDLs may be made available for each service/function available within media distribution system 18. Therefore, a first WSDL may be made available to generate a client stub for the account management services/functions of media distribution system 18; a second WSDL may be made available to generate a client stub for the library management services/functions of media distribution system 18; a third WSDL may be made available to generate a client stub for the metadata services/functions of media distribution system 18; a fourth WSDL may be made available to generate a client stub for the playback services/functions of media distribution system 18; and a fifth WSDL may be made available to generate a client stub for the search services/functions of media distribution system 18.

Account Management API:

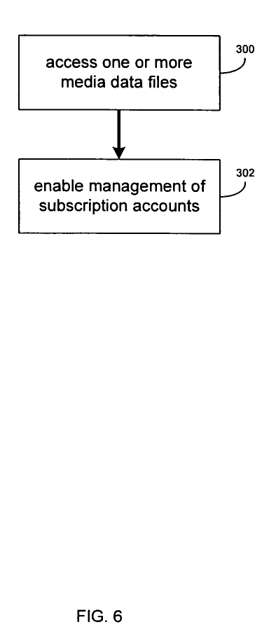

Referring also to FIG. 6, API 10 may be configured as an account management API that may enable a user (e.g., users 20, 24, 26) of a client electronic device (e.g., personal media device 38; personal digital assistant 40; cellular telephone 42) to access 300 one or more media data files chosen from the plurality of media data files (e.g., media data files 204). The account management API may be configured to enable the user (e.g., users 20, 24, 26) of the client electronic device (e.g., personal media device 38; personal digital assistant 40; cellular telephone 42) to manage 302 one or more subscription accounts associated with the media distribution system 18.

Media distribution system 18 may be a subscription-based service, in that the user (e.g., users 20, 24, 26) subscribes to media distribution system 18 and pays e.g., a monthly subscription fee to be granted access to media distribution system 18. Once the user (e.g., users 20, 24, 26) subscribes to media distribution system 18, the user may obtain media content (e.g., media data files 204) for use on the client electronic device, examples of which may include but are not limited to personal media device 38, personal digital assistant 40, cellular telephone 42, televisions (not shown); cable boxes (not shown); internet radios (not shown); or dedicated network devices (not shown).

As discussed above, the media content (e.g., media data files 204) obtained from media distribution system 18 may be in the form of: purchased downloads received from media distribution system 18 (i.e., media content licensed to e.g., users 20, 24, 26 for use in perpetuity); subscription downloads received from media distribution system 18 (i.e., media content licensed to e.g., users 20, 24, 26 for use while a valid subscription exists with media distribution system 18); and media content streamed from media distribution system 18, for example.

Typically, when accessing media distribution system 18, users 20, 24, 26 may be required to provide user “credentials” that identify the user (e.g., users 20, 24, 26) and/or the client electronic device (e.g., personal media device 38; personal digital assistant 40; cellular telephone 42) to media distribution system 18. Upon receiving these credentials, media distribution system 18 may attempt to verify the credentials and, if verified, grant users 20, 24, 26 and/or devices 38, 40, 42 access to media subscription system 18. The credentials received and verified by media distribution system 18 may include, but are not limited to, a user name, a user password, a user key, a device name, a device password, a device key, and/or one or more digital certificates.

When initially configuring a client electronic device, the user may be granted a “trial” subscription to media distribution system 18, thus allowing the user to try the service free of charge. Accordingly, the account management API (e.g., API 10) may be configured to allow for the generation of a “trial” subscription. However, these “trial” subscriptions may be for a limited time (e.g., one month) or provide limited use (e.g., 25 plays/downloads). Accordingly, API 10 may be configured to monitor the expiration date/time of a trial subscription and, upon the occurrence of the expiration date/time (or a date/time reasonably close thereto), API 10 may present the user (e.g., user 20, 24, 26) with the option to convert their “trial” subscription to a paid-for subscription. This offer may be presented to the user via e.g., display panel 90 (FIG. 2). In the event that the offer is accepted, the user may be required to provide additional information (e.g., billing information).

Other account management services/functions may be made available to the user (e.g., users 20, 24, 26) via the account management API (e.g., API 10). For example, API 10 may enable the user to: generate a new paid-for subscription with media distribution system 18; renew an existing paid-for subscription with media distribution system 18, cancel a trial subscription with media distribution system 18, and cancel a paid-for subscription with media distribution system 18, for example.

Library Management API:

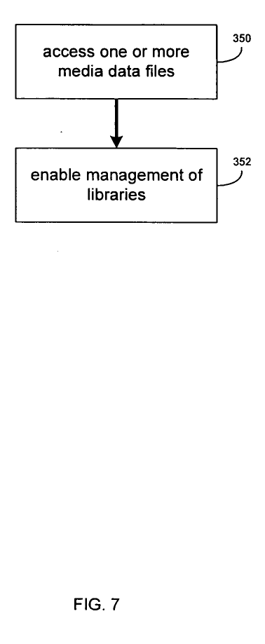

Referring also to FIG. 7, API 10 may be configured as a library management API that may enable a user (e.g., user 20, 24, 26) of a client electronic device (e.g., personal media device 38; personal digital assistant 40; cellular telephone 42) to access 350 one or more media data files chosen from the plurality of media data files (e.g., media data files 204). The library management API may be configured to enable the user (e.g., user 20, 24, 26) of the client electronic device (e.g., personal media device 38; personal digital assistant 40; cellular telephone 42) to manage 352 one or more media libraries associated with the media distribution system 18.

During use of the client electronic device, which may include but are not limited to personal media device 38, personal digital assistant 40, cellular telephone 42, televisions (not shown); cable boxes (not shown); internet radios (not shown); or dedicated network devices (not shown), the media content items (e.g., media data files 204) rendered on the client electronic device may be monitored and used to compile media history file 112 that defines the sequence of media content items rendered on the client electronic device. While media history file 112 is typically maintained locally (e.g., maintained in a memory on the client electronic device), media history file 112 may alternatively/additionally be maintained remotely (e.g., maintained on computer 28) as a remote media history file 112′.

Through the client electronic device, the user (e.g., users 20, 24, 26) may save media history file 112, 112′ (or portions thereof) as a playlist. An example of a playlist may include a group of media content items (e.g., streamed subscription tracks and albums, downloaded subscription tracks and albums, and purchased/ripped tracks) that media distribution system 18 may render in sequence. This, in turn, may allow the user to compile custom music compilations (in the form of multiple playlists).

The library management API (e.g., API 10) may enable the user of the client electronic device to manage 352 one or more media library files (e.g., library files 114, 114′) associated with the media distribution system 18. Similar to a playlist, media library file 114, 114′ may group, define and/or locate individual media content items (e.g., streamed subscription tracks and albums, downloaded subscription tracks and albums, and purchased/ripped tracks). While media library file 114 is typically maintained locally (e.g., maintained in a memory on the client electronic device), media library file 114 may alternatively/additionally be maintained remotely (e.g., maintained on computer 28) as a remote media library file 114′.

Other library management services/functions may be made available to the user (e.g., users 20, 24, 26) via the library management API (e.g., API 10). For example, API 10 may enable the user to: define a library file (e.g., library file 114, 114′), save a library file, delete a library file, modify a library file, share a library file (with another user of media distribution system 18), and publish a library file (for viewing by another user of media distribution system 18).

Metadata API:

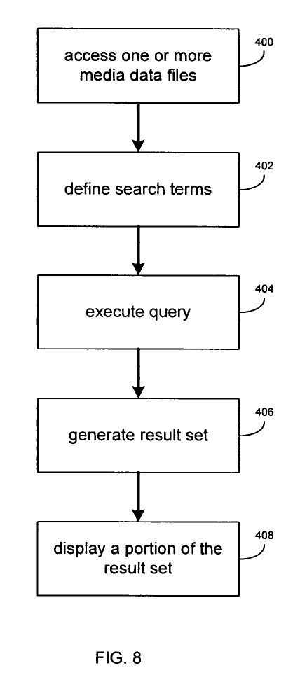

Referring also to FIG. 8, API 10 may be configured as a metadata API that may enable a user (e.g., users 20, 24, 26) of a client electronic device (e.g., personal media device 38; personal digital assistant 40; cellular telephone 42) to access 400 one or more media data files chosen from the plurality of media data files (e.g., media data files 204). The metadata application programming interface may be configured to enable the user (e.g., users 20, 24, 26) of the client electronic device (e.g., personal media device 38; personal digital assistant 40; cellular telephone 42) to define 402 one or more search terms. A query may be executed 404 on at least a portion of the plurality of media data files, based on the one or more search terms. A result set may be generated 406, and a portion of the result set may be displayed 408 to the user (e.g., users 20, 24, 26), such that the portion may be less than the entire result set.

As discussed above, media distribution system 18 may provide media data streams and/or media data files to users (e.g., users 20, 24, 26). Metadata may be associated with each media data stream and/or media data file provided by media distribution system 18. This metadata may include (but is not limited to) an artist identifier, an album identifier, a track identifier, an album cover image, a music genre identifier, and a priority rating, for example. Examples of a music genre identifier may include, but is not limited to, “Rock”, “Blues”, “Classical”, “Oldies”, and “Hip Hop”. Examples of a priority rating may include the numbers 1-10. Accordingly, a #1 priority rating may identify a very influential/popular artist and a #10 priority rating may identify an non-influential/unpopular artist. The priority ratings may be determined editorially, in that the ratings may be defined by employees of media distribution system 18. Alternatively/additionally, the priority ratings may be determined statistically, in that e.g., the number of times a track or artist is rendered (by any user) determines the priority rating of the artist.

As discussed above, the user (e.g., users 20, 24, 26) of the client electronic device may use search screen 100 in conjunction with e.g., slider assembly 88 to search/browse the media content stored within personal media device 12, 38 and/or available from media distribution system 18. In addition to artist field 102, album field 104, and track field 106, search screen 100 may include an genre field 116 and a priority field 118. Using e.g., slider assembly 88, the user may navigate fields 102, 104, 106, 116, 118 and enter the appropriate search terms into the appropriate field.

The metadata API (e.g., API 10) may enable the user (e.g., users 20, 24, 26) of the client electronic device (e.g., personal media device 38; personal digital assistant 40; cellular telephone 42) to define 402 one or more search terms within e.g., fields 102, 104, 106, 116, 118. For example, fields 102, 104, 106 may be left blank, and the user may enter the word “blues” into genre field 116 and “10” into priority field 118. As discussed above, when populating a field (e.g., fields 116, 118), slider assembly 88 may be used to enter the appropriate characters. Once the search terms are defined, the user may select “search” button 108 or (alternatively) “cancel” button 110.

If “search” button 108 is selected, a query may be executed 404 on at least a portion of the plurality of media data files, based on the one or more search terms. For example, if the search terms are “blues” (for genre) and “10” (for priority rating), API 10 may query the media data files (e.g., media data files 204) to determine which media data files satisfy the query (i.e., which media data files have a priority rating of “10” and are classified as “blues”). As discussed above, metadata may be used to define the priority rating and genre of a media data file. Accordingly, by searching the metadata associated with a media data file, a result set may be generated 406. As a client electronic device may include a comparatively small display panel (e.g., display panel 90, FIG. 2), the unrestrained generation of a result set that exceeds the display potential of the display panel may not be desirable. For example, if display panel 90 is capable of displaying a result set that includes up to ten line items and the result set generated include three-hundred-fifty line items, it may be desirable to display the result set in ten line item increments. Accordingly, API 10 may display 408 only a portion of the result set to the user (e.g., users 20, 24, 26), such that the portion may be less than the entire result set. Accordingly, in the event of a large result set and a display panel that is capable of displaying a maximum of ten items, API 10 may display line items 1-10. In order to see line items 11-20 on display panel 90, the user may be required to e.g., move slider assembly 88 in a downward direction.

Additionally/alternatively, for a large result set, API 10 may render a alphabetic index that identifies the starting line item for each letter of the alphabet. For example, if the three-hundred-fifty line item result set is generated, an alphabetic index may be rendered on display panel 90. An example of such an alphabetic index is as follows:

| Total Results | 350 |
|---|---|
| A's | 1 |
| B's | 15 |
| C's | 26 |
| D's | 40 |
| E's | 50 |
| F's | 62 |
| G's | 75 |
| H's | 90 |
| I's | 98 |
| J's | 110 |
| K's | 123 |
| L's | 140 |
| M's | 160 |
| N's | 181 |
| O's | 202 |
| P's | 228 |
| Q's | 245 |
| R's | 250 |
| S's | 275 |
| T's | 293 |
| U's | 305 |
| V's | 312 |
| W's | 326 |
| X's | 340 |
| Y's | 345 |
| Z's | 348 |

Accordingly for a result set that includes three-hundred fifty line items, the alphabetic index (rendered by API 10) may define the starting line item for each letter of the alphabet. For example, if the user was interested in “Robert Johnson”, the user may skip forward to line item 110, as “Robert Johnson” will be listed somewhere within line item 110 and line item 122 (i.e., assuming that the artists are listed in a last name, first name format).

When API 10 renders the alphabetic index, the user may be able to select the appropriate line item starting point (e.g., line item 110) using e.g., slider assembly 88. Once the user selects the appropriate line item starting point (e.g., line item 110), API 10 may render a defined number of line items (e.g., ten) within e.g., display panel 90. For example, upon selecting “110” from the above-described alphabetic index, API 10 may render (within display panel 90) line items 110-119. If the user wishes to see the next ten line items, the user may e.g., use slider assembly 88.

Playback API:

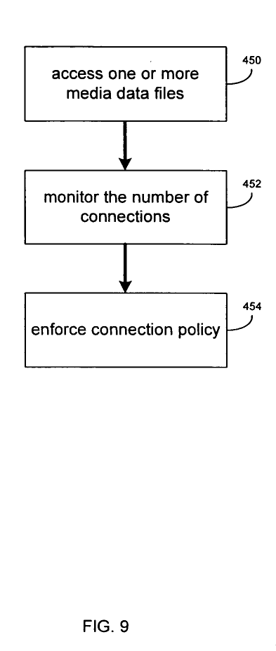

Referring also to FIG. 9, API 10 may be configured as a playback API that enables a user (e.g., users 20, 24, 26) of a client electronic device (e.g., personal media device 38; personal digital assistant 40; cellular telephone 42) to access 450 one or more media data files chosen from the plurality of media data files (e.g., media data files 204). The playback API may be configured to monitor 452 the number of connections, established by the user (e.g., user 20, 24, 26), with music distribution system 18. A maximum connection policy may be enforced 454 that limits the number of connections establishable by the user (e.g., users 20, 24, 26) to a defined connection limit.

Specifically, music distribution system 18 may be configured to work with multiple devices. For example, client electronic devices (e.g., personal media device 38, personal digital assistant 40 and cellular telephone 42) may allow the user (e.g., user 20, 24, 26) to access media distribution system 18 remotely (e.g., while in the car, jogging, hiking, or exercising). Additionally, client computer 44 may allow the user to access media distribution system 18 while at home or at work. Further, a dedicated network devices (e.g., A Roku™ Soundbridge M500, M1000 and M2000; not shown) may interface media distribution system 18 with a home entertainment system (not shown), thus allowing media content items to be rendered using the home entertainment system. Accordingly, media distribution system 18 may be configured to allow a single subscription to support multiple simultaneous connections. Therefore, a user may be able to access media distribution system 18 while at work and the spouse of the user may simultaneously be able to access media distribution system 18 while at home.

Accordingly, the playback API may be configured to monitor 452 the number of connections, established by the user (e.g., user 20, 24, 26), with music distribution system 18. A maximum connection policy may be enforced 454 that limits the number of connections establishable by the user (e.g., users 20, 24, 26) to a defined connection limit. Accordingly, if the defined connection limit is two, the user may be able to access media distribution system 18 (e.g., from work) while the user's spouse simultaneously may access media distribution system 18 (e.g., from home). However, if the son of the user tries to simultaneously access media distribution 18 while jogging (using personal media device 38), the connection may be refused, as (in the example) allowing the third connection would exceed the exemplary connection limit of two simultaneous connects.

Search API:

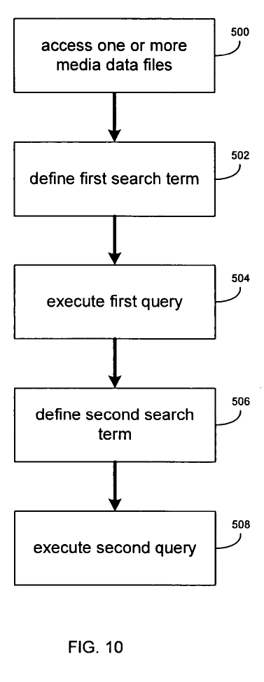

Referring also to FIG. 10, API 10 may be configured as a search API that may enable a user of a client electronic device (e.g., personal media device 38; personal digital assistant 40; cellular telephone 42) to access 500 one or more media data files chosen from the plurality of media data files (e.g., media data files 204). The search API may be configured to enable a user (e.g., users 20, 24, 26) to define 502 a first search term, and execute 504 a first query of at least a portion of the plurality of media data files, based on the first search term. A user (e.g., users 20, 24, 26) may be enabled to define 506 a second search term, and execute 508 a second query of at least a portion of the plurality of media data files, based on the first and second search terms.

As discussed above, the user (e.g., users 20, 24, 26) of the client electronic device may use search screen 100 in conjunction with e.g., slider assembly 88 to search/browse the media content stored within personal media device 12, 38 and/or available from media distribution system 18. Search screen 100 may include a plurality of search fields, such as artist field 102, album field 104, track field 106, genre field 116, and priority field 118.

In addition to the search procedure described above, a query may be automatically executed after each character is entered into one of fields 102, 104, 106, 116, 118. For example, if the user defines 502 the “J” from “Johnson”, a query may be automatically executed 504 to determine which artists have a last name that begins with “J”. This may result in e.g., 50,000 possible matches. The user may then define 506 a second term (namely “O”) into artist field 102 (for a total of two search terms, namely “JO”) and a second query may be automatically executed 508. This may result in e.g., 30,000 possible matches. The user may then continue to enter additional letters (resulting in a higher total number of search terms) until the result set is e.g., a size that is easily navigatable on display panel 90. Accordingly, for an artist that has a last name that is both unique and long, the user may only be required to enter a small portion of that user's last name (as opposed to the whole last name) to generate a manageable result set.

A number of implementations have been described. Nevertheless, it will be understood that various modifications may be made. Accordingly, other implementations are within the scope of the following claims.

What is claimed is:

1. A media distribution system comprising:
a media repository for storing a plurality of media data files; and
an account application programming interface configured to:
enable a user of a client electronic device to access one or more media data files chosen from the plurality of media data files; and
enable the user of the client electronic device to manage one or more subscription accounts associated with the media distribution system.

2. The media distribution system of claim 1 wherein the account application programming interface includes one or more servers stubs that are configured to communicate with one or more client stubs.

3. The media distribution system of claim 1 wherein the account application programming interface is further configured to:
receive a data request, using a standardized protocol, from the client electronic device; and
provide data, in response to the received data request, to the client electronic device in a third party usable format.

4. A method comprising:
storing a plurality of media data files within a media repository;
enabling a user of a client electronic device to access one or more media data files chosen from the plurality of media data files; and
enabling the user of the client electronic device to manage one or more subscription accounts associated with the media distribution system.

5. A media distribution system comprising:
a media repository for storing a plurality of media data files; and
a library management application programming interface configured to:
enable a user of a client electronic device to access one or more media data files chosen from the plurality of media data files; and
enable the user of the client electronic device to manage one or more media libraries associated with the media distribution system.

6. The media distribution system of claim 5 wherein the library management application programming interface includes one or more servers stubs that are configured to communicate with one or more client stubs.

7. The media distribution system of claim 5 wherein the library management application programming interface is further configured to:
receive a data request, using a standardized protocol, from the client electronic device; and
provide data, in response to the received data request, to the client electronic device in a third party usable format.

8. A method comprising:
storing a plurality of media data files within a media repository;
enabling a user of a client electronic device to access one or more media data files chosen from the plurality of media data files; and
enabling the user of the client electronic device to manage one or more media libraries associated with the media distribution system.

9. A media distribution system comprising:
a media repository for storing a plurality of media data files; and
a metadata application programming interface configured to:
enable a user of a client electronic device to access one or more media data files chosen from the plurality of media data files;
enable the user of the client electronic device to define one or more search terms;
execute a query on at least a portion of the plurality of media data files, based on the one or more search terms;
generate a result set; and
display a portion of the result set to the user, such that the portion is less than the entire result set.

10. The media distribution system of claim 9 wherein the metadata application programming interface includes one or more servers stubs that are configured to communicate with one or more client stubs.

11. The media distribution system of claim 9 wherein the metadata application programming interface is further configured to:
receive a data request, using a standardized protocol, from the client electronic device; and
provide data, in response to the received data request, to the client electronic device in a third party usable format.

12. A method comprising:
storing a plurality of media data files within a media repository;
enabling a user of a client electronic device to access one or more media data files chosen from the plurality of media data files;
enabling the user of the client electronic device to define one or more search terms;
executing a query on at least a portion of the plurality of media data files, based on the one or more search terms;
generating a result set; and
displaying a portion of the result set to the user, such that the portion is less than the entire result set.

13. A media distribution system comprising:
a media repository for storing a plurality of media data files; and
a playback application programming interface configured to:
enable a user of a client electronic device to access one or more media data files chosen from the plurality of media data files;
monitor the number of connections, established by the user, with the media distribution system; and
enforce a maximum connection policy that limits the number of connections establishable by the user to a defined connection limit.

14. The media distribution system of claim 13 wherein the playback application programming interface includes one or more servers stubs that are configured to communicate with one or more client stubs.

15. The media distribution system of claim 13 wherein the playback application programming interface is further configured to:
receive a data request, using a standardized protocol, from the client electronic device; and
provide data, in response to the received data request, to the client electronic device in a third party usable format.

16. A method comprising:
storing a plurality of media data files within a media repository;
enabling a user of a client electronic device to access one or more media data files chosen from the plurality of media data files;
monitoring the number of connections, established by the user, with a media distribution system; and
enforcing a maximum connection policy that limits the number of connections establishable by the user to a defined connection limit.

17. A media distribution system comprising:
a media repository for storing a plurality of media data files; and
a search application programming interface configured to:
enable a user of a client electronic device to access one or more media data files chosen from the plurality of media data files;
enable a user to define a first search term;
execute a first query of at least a portion of the plurality of media data files, based on the first search term;
enable a user to define a second search term; and
execute a second query of at least a portion of the plurality of media data files, based on the first and second search terms.

18. The media distribution system of claim 17 wherein the search application programming interface includes one or more servers stubs that are configured to communicate with one or more client stubs.

19. The media distribution system of claim 17 wherein the search application programming interface is further configured to:
receive a data request, using a standardized protocol, from the client electronic device; and
provide data, in response to the received data request, to the client electronic device in a third party usable format.

20. A method comprising:
storing a plurality of media data files within a media repository;
enabling a user of a client electronic device to access one or more media data files chosen from the plurality of media data files;
enabling a user to define a first search term;
executing a first query of at least a portion of the plurality of media data files, based on the first search term;
enabling a user to define a second search term; and
executing a second query of at least a portion of the plurality of media data files, based on the first and second search terms.
